(19) United States
(12) Patent Application Publication
(10) Pub. No.: US 2024/0053824 A1
(43) Pub. Date: Feb. 15, 2024

(54) SYSTEM AND METHOD FOR NEUROLOGICAL TRIGGER, ACTIVATION OR CONTROL OF A COMPUTER USER INTERFACE WITHOUT EXTERNAL STIMULUS

(71) Applicant: NURO CORP., Guelph (CA)

(72) Inventors: Francois GAND, Guelph (CA); Abhinav KUMAR, Uttar Pradesh (IN)

(21) Appl. No.: 18/266,197

(22) PCT Filed: Dec. 6, 2021
(86) PCT No.: PCT/CA2021/051738

§ 371 Date: Jun. 8, 2023

Related U.S. Application Data
(60) Provisional application No. 63/123,647, filed on Dec. 10, 2020.

(51) Int. Cl. G06F 3/01

(52) U.S. Cl. CPC G06F 3/015

(57) ABSTRACT

A method of and system for human interactions with a computer user interface using neurological signals from the frontal part of the human brain, also known as the prefrontal cortex. In one embodiment, the system comprised a brain-computer interface system and a method of filtering, processing and analyzing neurological signals over a specific period of time to trigger, activate or control on-demand a computer user interface without the need of any preliminary brain state recording nor traditionally-required external stimulus.

### CROSS-REFERENCE TO RELATED APPLICATIONS

This claims the benefit of U.S. Provisional Patent Application No. 63/126,647, filed Dec. 10, 2020, the contents of which are incorporated by reference in their entirety.

### FIELD OF THE INVENTION

The present method and system relate generally to Human-Electronics Interfaces and more specifically to a process for humans to control a computer user interface using a neurologically-based measurement over a time measurement without the need of external stimuli.

### BACKGROUND OF THE INVENTION

Since 1973, brain-computer interfaces have typically used invasive or non-invasive methods and systems based on physiological responses to certain stimuli, namely motor imagery (MI), event related potentials (ERP) or visual evoked potentials (VEP).

With motor imagery, an individual mentally rehearses or simulates a physical action, such as moving a limb. It is widely used in sports training and in neurological rehabilitation with the purpose of improving strength and function. In brain-computer interfaces, motor imagery is identifiable in the human brain's centrally-located sensorimotor cortex which can detect the electrical feature generated by the motor imagery task. It has been shown that mental imagery of a motor action can produce cortical activation similar to that of the same action executed. For instance, the execution of a hand movement results in the suppression of mu rhythm (8-12 Hz) in the electroencephalography monitoring the sensorimotor region as does the motor imagery of the corresponding hand. As such, motor imagery BCI has used this phenomenon as a limited triggering mechanism for binary states in brain-computer interfaces.

It is to be noted that studies have shown that motor imagery BCI requires extensive set-up and training time often accompanied with unsuccessful and unsatisfying results in the beginning requiring from the human subject both constant motivation and accurate perception of control. Once achieved, a computer user interface can be triggered via the controlled stimulus.

With event related potentials, an electrical positive polarity is achieved within a biologically-known time range in response to infrequent or oddball auditory, visual or somatosensory stimuli in a stream of frequent stimuli.

The P300 signal is a known methodology in event related potentials-based brain-computer interfaces whereas an infrequent or oddball stimulus triggers an electrical response in the electroencephalogram recording of a subject with a time-locked physiological latency between 300 and 600 milliseconds.

The P300 paradigm is involved with the process of memory modification or learning and things appear to be learned if, and only if, they are surprising.

Studies have demonstrated that the most remarkable P300 signal is recorded via electroencephalography in the middle or rear part of the human head also known as the parietal bone district.

Most humans generate the P300 signal to such external stimuli and this has allowed this methodology to be used in the triggering of a computer user interface although several issues have limited the generic use of P300-based brain-computer interfaces outside of the research laboratory.

Documented challenges for event related potentials are that electroencephalographic signal patterns change in response to various factors such as mental state, learning, fatigue, motivation, repetition blindness, distraction, habituation, eye blinks and other nonstationarities that exist in the human brain. These factors generate noise in the P300 signal detection.

Human subjects have unique electroencephalographic signal patterns that make it necessary for individualized calibration when using event related potentials. Such limitations require significant support. An expert is needed to identify and assemble the components, customize parameters to each subject, access appropriately the scalp of most users for optimal electrode positions and address acute problems based on individuation.

With visual evoked potentials, visual flickers on a computer screen are used as stimuli for soliciting a response from the occipital cortex, the back area of the brain involved in receiving and interpreting visual signals. The visual evoked potential measures the time that it takes for the visual stimulus to travel from the eye to the occipital cortex.

For high accuracy, embodiments for the processing of visual evoked potentials generally require multiple repeated training sessions whereas subjects are asked to shift their gaze to a flashing target as soon as possible for the stimulus to be used in the triggering of a computer user interface.

Studies have demonstrated that visual evoked potentials with repetitive flashing or variations of light may present occurrences of mental and visual fatigue with a decrease arousal level worsening the signal quality, its amplitude and consequently degrading the practical performance of that methodology.

Therefore brain-computer interfaces can benefit from a novel and innovative method and system to reliably trigger or control a computer user interface without the above limitations. Embodiments of the present invention seek to address one or more of the aforementioned problems.

### SUMMARY OF THE INVENTION

In one aspect of the invention, a novel and innovative method is provided which is not utilizing any of the three traditional paradigms which brain-computer interfaces have been relying on, namely the use of at least one external stimulus from motor imagery, event related potentials or visual evoked potentials for a human subject to generate a neurological trigger to control a computer user interface.

In another aspect of the invention, a novel and innovative method is provided which is strictly utilizing neurological signals free of external stimulus from the practical hairless frontal part of the human head, namely the prefrontal cortex, and not from any of the central or rear sections of the human head classically used by the three traditional paradigms which brain-computer interfaces have been relying on, namely external stimulus-dependent and research lab-centric motor imagery, event related potentials or visual evoked potentials.

In another aspect of the invention, a novel and innovative method and system are provided which allows a stimulus-free, reliable and fast interaction with a computer user interface by neurological signal strictly based on a specific relationship between the power of a neurological signal emitted by the brain of a human subject, a specific set of thresholds and a time duration.

In another aspect of the invention, an improved brain-computer interface system for the control of musical tracks is provided.

In another aspect of the invention, an improved brain-computer interface system for the control of video playlists is provided.

In another aspect of the invention, an improved brain-computer interface system for the control of communication by non-communicating incapacitated human subjects is provided.

In another aspect of the invention, an improved brain-computer interface system for the control of a smart assistant or Internet of Things (IoT) smart device is provided.

In another aspect of the invention, an improved brain-computer interface system for the control of a computer game or elements of a computer game is provided.

### BRIEF DESCRIPTION OF THE DRAWINGS

In order to describe the method and system hereinabove-recited, a more particular description of the subject matter will be rendered by reference to specific embodiments which are illustrated in the appended drawings. In these drawings, the embodiments of the invention ought to be considered as illustrated by way of example. It is to be understood that these drawings and descriptions are only for the purpose of illustration and as an aid to understanding and are therefore not to be considered to be limited in scope. Embodiments will be explained in detail through the use of the accompanying drawings in which:

FIG. 1 shows a flowchart illustrating the manual methodology or the automated methodology to process a neurological signal for triggering, activating or controlling a computer user interface without the need of an external stimulus.

FIG. 2 illustrates how a neurological signal can be isolated as a direct trigger, activation or control of a computer user interface via an analysis of a sustained power of a neurological signal over a predefined power threshold across a predefined time duration.

FIG. 3 illustrates the processing scheme for manual or automated treatment of a neurological signal for triggering, activating or controlling a computer user interface without the need of an external stimulus.

FIG. 4 illustrates an embodiment of a novel and innovative system to control musical tracks and a music playlist in accordance with the present invention.

FIG. 5 illustrates an embodiment of a novel and innovative system to control videos and a video playlist in accordance with the present invention.

FIG. 6 illustrates an embodiment of a novel and innovative system to control communication by non-communicating incapacitated human subjects in accordance with the present invention.

FIG. 7 illustrates an embodiment of a novel and innovative system to control a smart assistant or Internet of Things (IoT) smart device in accordance with the present invention.

FIG. 8 illustrates an embodiment of a novel and innovative system to control a computer game or elements of a computer game in accordance with the present invention.

### DETAILED DESCRIPTION

The present invention relates to the processing of neurological signals to trigger, activate or control a computer user interface without the need to rely on any external stimulus. More specifically, the present invention provides a method and a system as to how a neurological signal can be immediately isolated and used as a direct trigger, activation or control of a computer user interface without the traditional reliance of an initial brain state recording based on an external stimulus.

As further explained below, the present invention provides a method and a system for a neurological signal to be used as a direct trigger, activation or control of a computer user interface via the live analysis of a sustained power of a neurological signal over a set threshold over a specific time duration.

Unless specifically stated otherwise, the present invention implicitly discloses the use of various generally-available machines such as a non-invasive or invasive, wired or wireless electroencephalograph with an array of electrodes specifically placed on or near the forehead of a human subject, also known as the prefrontal cortex, and a computer to capture and apply pre-processing and noise filtering on neurological signals from this hairless frontal part of the human head. These machines are generally used by those skilled in the art and they are only mentioned for the purpose of performing steps of the novel and innovative method and supporting the presentation of several embodiments of the system.

There is a preponderance of multiple known frequencies associated with neurological signals and the present invention is tailored to work from the live isolation and processing of one or a concatenation of any frequency at any scale of any neurological signal as long the human subject is capable of physiologically emitting such neurological signal. Once any neurological signal is physiologically emitted from the prefrontal cortex, such signal is technically obtainable, visible, filterable and trackable from an electroencephalographic perspective. Neurological signals will be emitted with a certain power by a human subject and depending on the state of the human being, from healthy to highly incapacitated, the power of the neurological signals will vary in strength, amplitude and duration, three key factors which can be used in a specific method to trigger, activate or control a computer user interface.

In one embodiment, a neurological signal filtering associated with mental focus can be emitted by a human subject with various strengths, amplitude and duration. A human subject can naturally generate a significantly stronger or weaker mental focus or power associated with the mental focus depending on the physiological or pathophysiological state of the human subject. Same would apply with other types of neurological signals known to be associated with other mental states such as calmness, mental effortness, emotion, appreciation and more. This applies as well to other types of neurological signals such as the ones emitted during human eye movements distinguishable via electrooculography or from any muscle activity from the frontal part of the human head distinguishable via electromyography. The present invention provides a method to determine if any power from any neurological signal is capable of sustaining its power level below, at or above a specific signal power threshold. Furthermore, the present invention provides this three-tiered determination based on a set time duration threshold. The correlation between the immediate determination of what the power of any neurological signal is versus any set power threshold versus any set duration of time can be the basis for an immediate trigger, activation or control of a computer user interface.

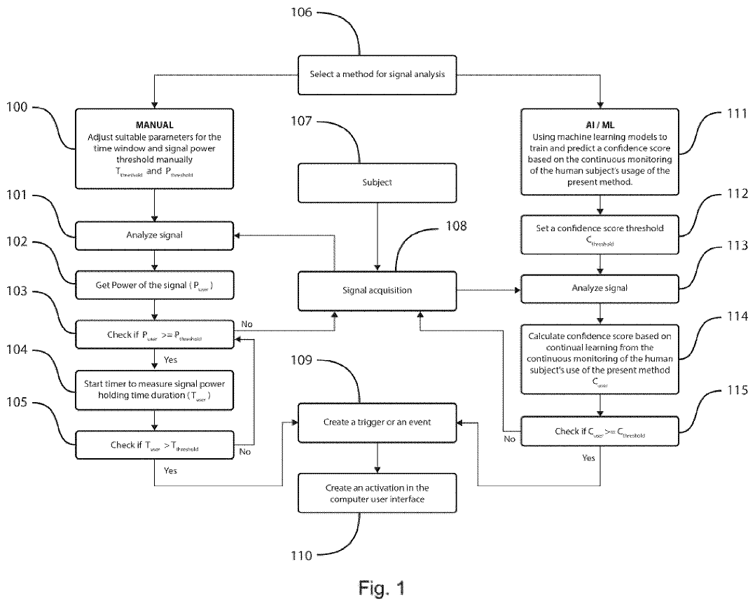

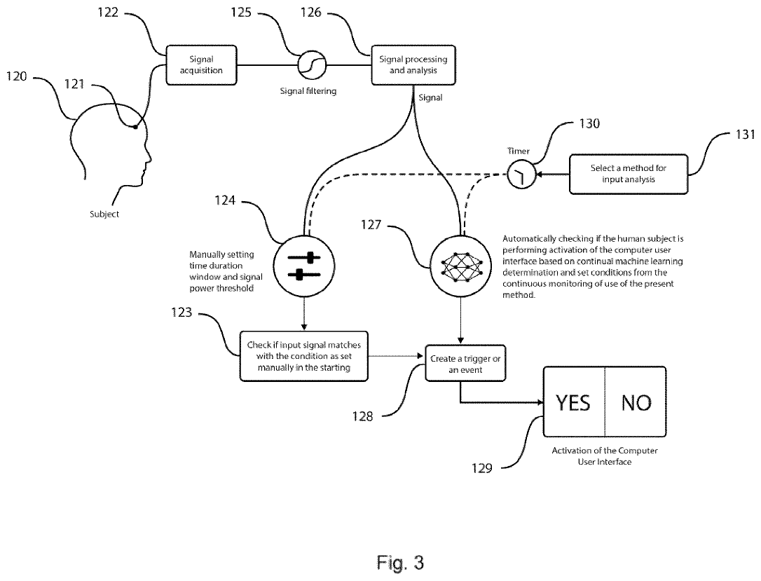

The present invention provides two separate methodologies to determine the above result as per FIG. 1 and FIG. 3: one established via the manual analysis of the live neurological signals 124, the other via the automated analysis of the live neurological signals via continual machine learning 127 whereas conditions for activations of a computer user interface are constantly evaluated via a confidence score based on the continuous monitoring of the human subject's usage of the system in accordance with the method 115.

In the manual analysis of the live neurological signals as described in the present invention, the power of a live neurological signal from a human subject is immediately compared against a predefined signal power threshold 103 and predefined time duration threshold 105.

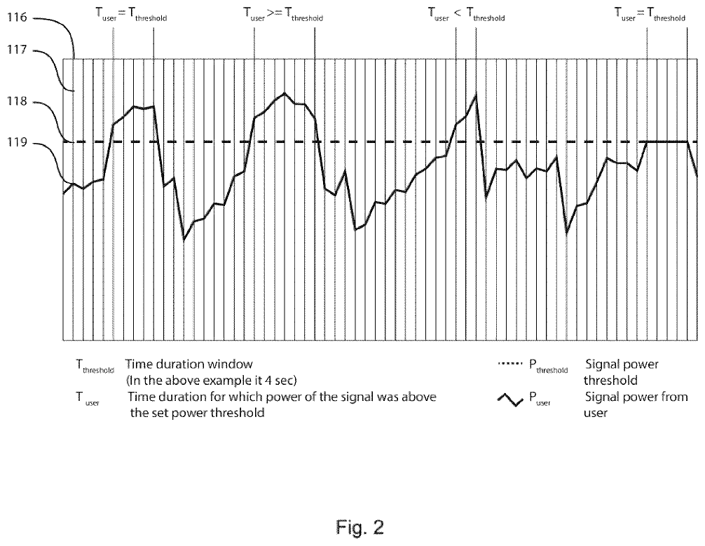

As per FIG. 2, once the thresholds are set 118, 135, 155, 172, 190, 208, the power of the signal (Pᵤₛₑᵣ) can immediately be measured as below, at or above the predefined signal power threshold (P_{threshold}) 103 for a predefined time duration window (T_{threshold}) 105, 123.

When the power of the signal (Pᵤₛₑᵣ) is at or above the predefined signal power threshold (P_{threshold}) 103, the system launches a timer 130 to measure the time duration (Tᵤₛₑᵣ) for which the human subject is able to generate or hold the power of the signal (Pᵤₛₑᵣ) at or above the signal power threshold (P_{threshold}) 116.

Upon the launch of a timer to measure the time duration (Tᵤₛₑᵣ) for which the human subject is able to generate or hold the power of the signal (Pᵤₛₑᵣ) at or above the signal power threshold (P_{threshold}), three conditions 116, 123 will then determine if a trigger or activation of a computer user interface is achieved (determined as True) or not (determined as False) 109, 110, 128, 129.

Condition 1a is as follows: if (Tᵤₛₑᵣ=T_{threshold}) then Activation is True 116.

When the human subject is able to generate or hold the power of signal (Pᵤₛₑᵣ) at or above (Pᵤₛₑᵣ>=P_{threshold}) the predefined signal power threshold (P_{threshold}) for a predefined time duration (Tᵤₛₑᵣ=T_{threshold}), the system creates a trigger or activation in the computer user interface 109, 110, 128, 129.

Condition 2a is as follows: if (Tᵤₛₑᵣ>T_{threshold}) then Activation is True 116.

When the human subject is able to generate or hold the power of signal (Pᵤₛₑᵣ) at or above (Pᵤₛₑᵣ>=P_{threshold}) the predefined signal power threshold (P_{threshold}) for a predefined time duration (T_{threshold}) and beyond (Tᵤₛₑᵣ>T_{threshold}), the system creates a trigger or activation in the computer user interface only once 109, 110, 128, 129. Upon a first trigger or activation being true in the computer user interface, in order to create another subsequent trigger or activation in the computer user interface, the human subject will need to first lower the power of the signal (Pᵤₛₑᵣ) below the predefined threshold (Pᵤₛₑᵣ<P_{threshold}) and then re-establish the Condition 1a or the Condition 2a as True in accordance with the presented methodology 116.

Condition 3a is as follows: if (Tᵤₛₑᵣ<T_{threshold}) then Activation is False 116.

If the human subject is not able to generate or hold the power of signal (Pᵤₛₑᵣ>=P_{threshold}) for the predefined time duration, then no trigger or activation is generated in the computer user interface.

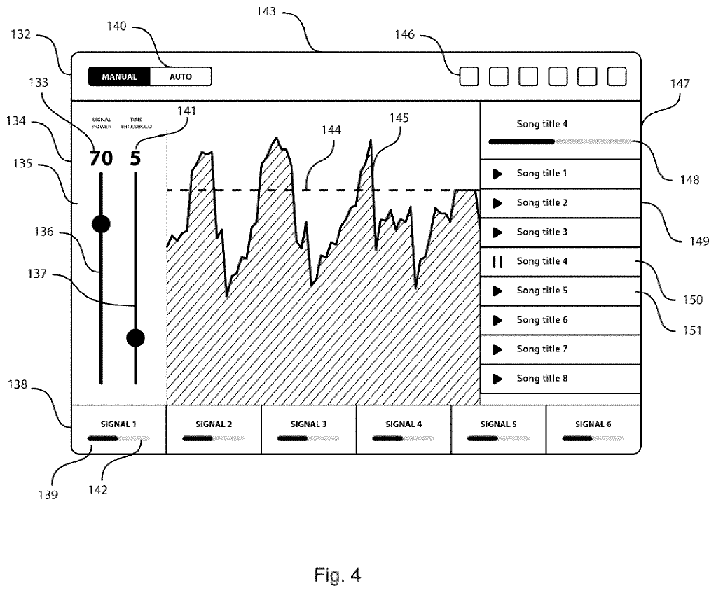

In another embodiment, the present invention provides a system for the triggering, activation and control of musical tracks and musical playlists without the need of an extemal stimulus 143. More specifically, as per FIG. 4, the described method is used for playing, pausing and switching music by a human subject using a neurological signal from that human subject without the need of an external stimulus 134, 138, 140, 144, 145, 147.

In this embodiment, in order to start playing a musical track from a musical playlist 148, 149, 150, 151 the power of a neurological signal has to achieve either of the conditions as herein-above described in Condition 1a or Condition 2a.

In this embodiment, in order to change the music to the next track in the musical playlist, the power of a neurological signal has to achieve either of the conditions as herein-above described in Condition 1a or Condition 2a.

In order to keep this neurologically-controlled music player 147 idle and not play nor launch the next music track, the power of a neurological signal must remain below the predefined power threshold so that it never activates the timer 116. Alternatively, if the power of the signal goes above the predefined power threshold and activates the timer then reducing the power of the signal below the predefined threshold within the predefined time duration of the activated timer will reset it, which will generate a matching condition as per the herein-above Condition 3a and thus not create any triggering or activation of the computer user interface.

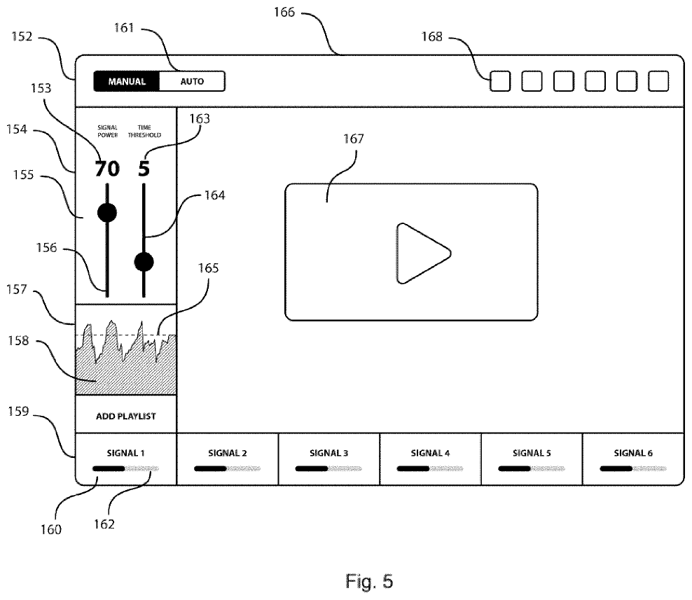

In another embodiment, the present invention provides a system for the triggering, activation and control of videos and video playlists without the need of an external stimulus 166. More specifically, as per FIG. 5, the described method is used for playing, pausing and switching video by a human subject using a neurological signal from that human subject without the need of an external stimulus 154,157, 158, 159, 161, 165.

In this embodiment, in order to start playing a video from a video playlist, the power of a neurological signal has to achieve either of the conditions as herein-above described in Condition 1a or Condition 2a.

In this embodiment, in order to change the video to the next video in the video playlist, the power of a neurological signal has to achieve either of the conditions as herein-above described in Condition 1a or Condition 2a.

In order to keep this neurologically-controlled video player 166,167 idle and not play nor launch the next video track, the power of a neurological signal must remain below the predefined power threshold so that it never activates the timer. Alternatively, if the power of the signal goes above the predefined power threshold and activates the timer then reducing the power of the signal below the predefined threshold within the predefined time duration of the activated timer will reset it, which will generate a matching condition as per the herein-above Condition 3a and thus not create any triggering or activation of the computer user interface.

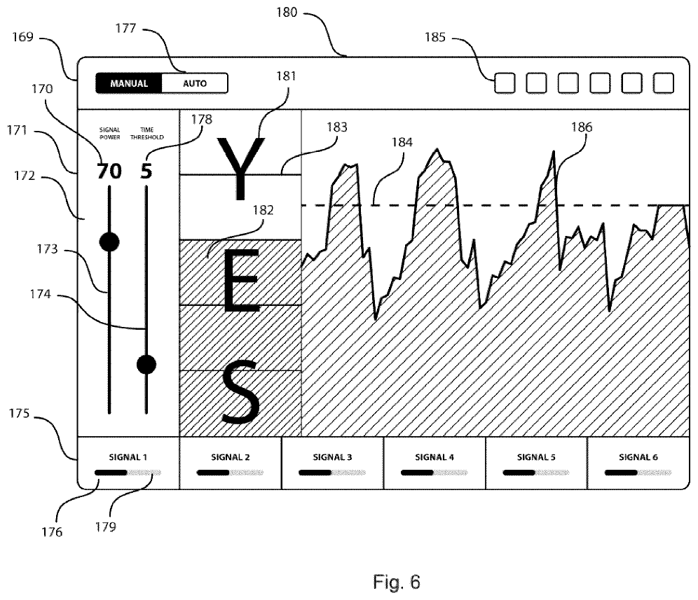

In another embodiment, the present invention provides a system for the control of communication without the need of an external stimulus 180. More specifically, as per FIG. 6, the described method is used for providing basic communication capabilities by any human subject, including a non-communicating highly incapacitated human subject, using a neurological signal from that human subject without the need of an external stimulus 171, 175, 177, 184, 186.

In this embodiment, in order to activate a trigger, activation or response for communication, the power of a neurological signal has to achieve either of the conditions as herein-above described in Condition 1a or Condition 2a.

In order to prevent a trigger, activation or response for communication, the power of a neurological signal must remain below the predefined power threshold so that it never activates the timer. Alternatively, if the power of the signal goes above the predefined power threshold and activates the timer then reducing the power of the signal below the predefined threshold within the predefined time duration of the activated timer will reset it, which will generate a matching condition as per the herein-above Condition 3a and thus not create any triggering or activation of the computer user interface.

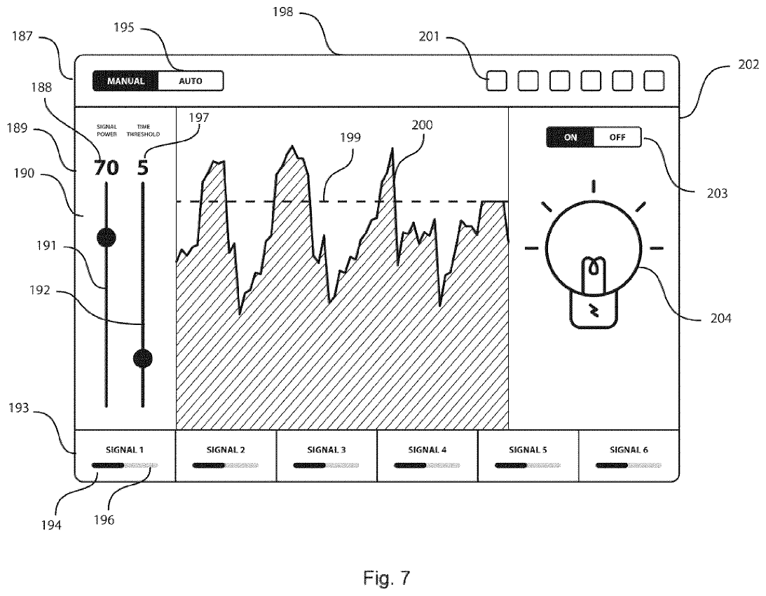

In another embodiment, the present invention provides a system for the triggering, activation and control of a smart assistant or Internet of Things (IoT) smart device without the need of an external stimulus 198. More specifically, as per FIG. 7, the described method is used for triggering or activating or deactivating smart assistive devices (such as a smart bulb, a smart home temperature controller, a smart home security system, a smart robotic device, a smart assistive device such as an exoskeleton, a smart digital assistant or a programmatically-scripted set of commands for controlling such devices and more) by a human subject using a neurological signal from that human subject without the need of an external stimulus 189, 193, 195, 199, 200.

In this embodiment, in order to start activating a smart assistant or Internet of Things (IoT) smart device, the power of a neurological signal has to achieve either of the conditions as herein-above described in Condition 1a or Condition 2a.

In this embodiment, in order to change the state of a smart assistant or Internet of Things (IoT) smart device, the power of a neurological signal has to achieve either of the conditions as herein-above described in Condition 1a or Condition 2a.

In order to not trigger, activate or change the state of a smart assistant or Internet of Things (IoT) smart device, the power of a neurological signal must remain below the predefined power threshold so that it never activates the timer. Alternatively, if the power of the signal goes above the predefined power threshold and activates the timer then reducing the power of the signal below the predefined threshold within the predefined time duration of the activated timer will reset it, which will generate a matching condition as per the herein-above Condition 3a and thus not create any triggering or activation of the computer user interface.

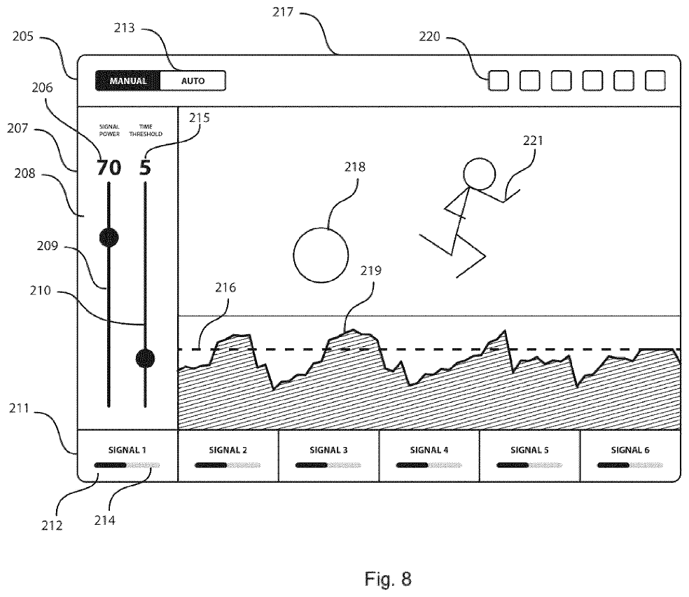

In another embodiment, the present invention provides a system for the triggering, activation and control of computer gaming without the need of an external stimulus 217. More specifically, as per FIG. 8, the described method is used for playing and interacting with a computer game or interactive or reactive elements of a computer game by a human subject using a neurological signal from that human subject without the need of an external stimulus 207, 211, 213, 216, 219.

In this embodiment, in order to start an interaction with a computer game or any interactive or reactive element in the computer game, the power of a neurological signal has to achieve either of the conditions as herein-above described in Condition 1a or Condition 2a.

In order to prevent an interaction with a computer game or any interactive or reactive element in the computer game, the power of a neurological signal must remain below the predefined power threshold so that it never activates the timer. Alternatively, if the power of the signal goes above the predefined power threshold and activates the timer then reducing the power of the signal below the predefined threshold within the predefined time duration of the activated timer will reset it, which will generate a matching condition as per the herein-above Condition 3a and thus not create any triggering or activation of the computer user interface.

In the automated analysis of a live neurological signal in accordance with the present invention, the power of a neurological signal is analyzed using a real-time continual machine learning model to receive a confidence score (Cᵤₛₑᵣ). This specific machine learning model takes two inputs for analysis: the power of the signal (Pᵤₛₑᵣ) and the holding power duration (Tᵤₛₑᵣ) for the calculation of the confidence score (Cᵤₛₑᵣ).

It is required to set a first confidence threshold (C_{threshold}) prior to the engagement of the user with the system. Once the threshold is set, the power of the signal (Pᵤₛₑᵣ) can immediately be analyzed with the real-time continual machine learning model to automatically determine and re-update the confidence score (Cᵤₛₑᵣ) and compare it with a predefined confidence threshold (C_{threshold}).

There will be two conditions that will determine if a trigger or activation of a computer user interface is achieved (determined as True) or not (determined as False).

Condition 1b is as follows: if (Cᵤₛₑᵣ>=C_{threshold}) then the activation is True.

When the confidence score provided by the real-time continual machine leaning model is higher than the predefined confidence threshold (C_{threshold}), the system creates a trigger or an event which activates the computer user interface.

Condition 2b is as follows: if (Cᵤₛₑᵣ<C_{threshold}) then the activation is False.

When the confidence score provided by the real-time continual machine leaning model is lower than the predefined confidence threshold (C_{threshold}), the system does not create a trigger or an event to activate the computer user interface.

In another embodiment, the present invention provides a system for the automated triggering, activation and control of musical tracks and musical playlists without the need of an external stimulus. More specifically, the described method is used for the automation of playing, pausing and switching music by a human subject using a neurological signal from that human subject without the need of an external stimulus.

In this embodiment, in order to start playing a musical track from a musical playlist, the confidence score provided by the real-time continual machine learning model should satisfy the condition as herein-above described in Condition 1b.

In this embodiment, in order to change the music to the next track in the musical playlist, the confidence value provided by the machine learning model should satisfy the condition as herein-above described in Condition 1b.

In order to keep this neurologically-controlled music player idle and not play nor launch the next music track, the confidence value provided by the machine learning model should satisfy the condition as herein-above described in Condition 2b.

In another embodiment, the present invention provides a system for the automated triggering, activation and control of videos and video playlists without the need of an external stimulus. More specifically, the described method is used for automatically playing, pausing and switching video by a human subject using a neurological signal from that human subject without the need of an external stimulus.

In this embodiment, in order to start playing a video from a video playlist, the confidence score provided by the real-time continual machine learning model should satisfy the condition as herein-above described in Condition 1b.

In this embodiment, in order to automatically change the video to the next video in the video playlist, the confidence score provided by the real-time continual machine learning model should satisfy the condition as herein-above described in Condition 1b.

In order to keep this neurologically-controlled video player idle and not play nor launch automatically the next video track, the confidence score provided by the real-time continual machine learning model should satisfy the condition as herein-above described in Condition 2b.

In another embodiment, the present invention provides a system for the automated activation and control of communication without the need of an external stimulus. More specifically, the described method is used for providing basic communication capabilities by any human subject, including a non-communicating highly incapacitated human subject, using a neurological signal from that human subject without the need of an external stimulus.

In this embodiment, in order to automatically create a trigger, activation or response for communication, the confidence score provided by the machine learning model should satisfy the condition as herein-above described in Condition 1b.

In order to prevent an automated trigger, activation or response for communication, the confidence score provided by the real-time continual machine learning model should satisfy the condition as herein-above described in Condition 2b.

In another embodiment, the present invention provides a system for the automated triggering, activation and control of a smart assistant or Internet of Things (IoT) smart device without the need of an external stimulus. More specifically, the described method is used for automatically triggering or activating or deactivating smart assistive devices (such as a smart bulb, a smart home temperature controller, a smart home security system, a smart robotic device, a smart assistive device such as an exoskeleton, a smart digital assistant or a programmatically-scripted set of commands for controlling such devices and more) by a human subject using a neurological signal from that human subject without the need of an external stimulus.

In this embodiment, in order to automate the activation of a smart assistant or Internet of Things (IoT) smart device, the confidence score provided by the real-time continual machine learning model should satisfy the condition as herein-above described in Condition 1b.

In this embodiment, in order to automatically change the state of a smart assistant or Internet of Things (IoT) smart device, the confidence score provided by the real-time continual machine learning model should satisfy the condition as herein-above described in Condition 1b.

In order to not automatically trigger, activate or change the state of a smart assistant or Internet of Things (IoT) smart device, the confidence score provided by the real-time continual machine learning model should satisfy the condition as herein-above described in Condition 2b.

In another embodiment, the present invention provides a system for the automated triggering, activation and control of computer gaming without the need of an external stimulus. More specifically, the described method is used for automatically playing with a computer game or any interactive or reactive element of a computer game by a human subject using a neurological signal from that human subject without the need of an external stimulus.

In this embodiment, in order to start an interaction with a computer game or any interactive or reactive element in the computer game, the confidence score provided by the real-time continual machine learning model should satisfy the condition as herein-above described in Condition 1b.

In order to prevent an automated triggering with the computer game or any interactive or reactive element in the computer game, the confidence score provided by the real-time continual machine learning model should satisfy the condition as herein-above described in Condition 2b.

### NUMERICAL REFERENCES

100. Manual method to set the predefined time duration window and the signal power threshold
101. Analysis of the neurological signal without external stimulus as per manual method
102. Determination of the power of the neurological signal without external stimulus
103. Check if the power of the neurological signal is equal or greater than the set threshold
104. Start of the timer to measure the neurological signal power holding time duration
105. Check if the signal power holding time is equal or greater than the predefined time window
106. Selection for manual or automatic processing of a live signal without external stimulus
107. Human subject emitting at least one neurological signal without external stimulus
108. Acquisition of the neurological signal without external stimulus with standard noise filtering
109. Creation of a trigger or event based on the manual or automated present methodology
110. Activation of the computer user interface as a result of the creation of a trigger or event
111. Automated method to continuously train and predict a confidence score based on usage
112. Determination of a confidence score threshold by the automated method
113. Analysis of the neurological signal without external stimulus as per automated method
114. Determination of a confidence score based on continual learning of the use of the method
115. Check if the confidence score is equal or greater than the confidence score threshold
116. Representation of the conditions when system creates a trigger or activation
117. Time axis representing divisions of time that are one (1) second apart
118. Representation of the predefined signal power threshold
119. Real-time representation of a live neurological signal from a human subject
120. Symbolization of a human subject and the related prefrontal cortex
121. Electrode placed on or near the prefrontal cortex to acquire live neurological signal
122. Acquisition of a live neurological signal without external stimulus
123. Determination if the analysis of the live signal matches with one of the method conditions
124. Manual method to set the predefined time duration window and the signal power threshold
125. Standard noise filtering of a live neurological signal without external stimulus
126. Real-time processing and analysis of a live neurological signal without external stimulus
127. Activation check of computer user interface based on automated method with conditions
128. Creation of a trigger or event based on the manual or automated present methodology
129. Activation of the computer user interface as a result of the creation of a trigger or event
130. Timer mechanism triggered by either selection of manual or automated method
131. Selection for manual or automatic processing of a live signal without external stimulus
132. Top section of the computer user interface containing elements from [140] and [148]
133. Numerical representation of the signal power threshold
134. Left sidebar of the interface containing the section for thresholds
135. Section in the computer user interface containing the settings for key thresholds
136. Slider to manually adjust the signal power threshold
137. Slider to manually adjust the time duration threshold
138. Bottom bar of the interface which contains all the signal processes algorithmically
139. Single tile in the bottom bar represents one of the processed neurological signals
140. Toggle button to switch between manual or automated mode for signal processing
141. Numerical representation of the predefined time duration threshold
142. Visual representation of numerical value of the algorithmically-processed signal
143. Computer user interface for interacting with musical tracks
144. Representation of the predefined signal power threshold
145. Real-time representation of a live neurological signal from a human subject
146. Set of interactive buttons to connect sensors and display their real-time status
147. Music interface containing elements from [148] and [149]
148. Progress bar representing the length of the track played with respect to actual track length
149. Musical playlist containing a list of music from local device
150. One of the active musical tracks in the musical playlist
151. One of the musical tracks in the musical playlist
152. Top section of the computer user interface containing elements from [161] and [168]
153. Numerical representation of the signal power threshold
154. Left sidebar of the interface containing sections from [155] and [157]
155. Section in the computer user interface containing the settings for key thresholds
156. Slider to manually adjust the signal power threshold
157. Section in the computer user interface containing elements from [158] and [165]
158. Real-time representation of a live neurological signal from a human subject
159. Bottom bar of the interface which contains all the signal processes algorithmically
160. Single tile in the bottom bar represents one of the processed neurological signals
161. Toggle button to switch between manual or automated mode for signal processing
162. Visual representation of numerical value of the algorithmically-processed signal
163. Numerical representation of the predefined time duration threshold
164. Slider to manually adjust the time duration threshold
165. Representation of the predefined signal power threshold
166. Computer user interface for interacting with videos
167. Symbolization of a video in the computer user interface
168. Set of interactive buttons to connect sensors and display their real-time status
169. Top section of the computer user interface containing elements from [177] and [185]
170. Numerical representation of the signal power threshold
171. Left sidebar of the interface containing the section for thresholds
172. Section in the computer user interface containing the settings for key thresholds
173. Slider to manually adjust the signal power threshold
174. Slider to manually adjust the time duration threshold
175. Bottom bar of the interface which contains all the signal processes algorithmically
176. Single tile in the bottom bar represents one of the processed neurological signals
177. Toggle button to switch between manual or automated mode for signal processing
178. Numerical representation of the predefined time duration threshold
179. Visual representation of numerical value of the algorithmically-processed signal
180. Computer user interface for communication
181. Visual representation of a communication response
182. Visual representation of the time duration for the holding power of the neurological signal
183. Visual representation of the time threshold as division
184. Representation of the predefined signal power threshold
185. Set of interactive buttons to connect sensors and display their real-time status
186. Real-time representation of a live neurological signal from a human subject
187. Top section of the computer user interface containing elements from [195] and [201]
188. Numerical representation of the signal power threshold
189. Left sidebar of the interface containing the section for thresholds
190. Section in the computer user interface containing the settings for key thresholds
191. Slider to manually adjust the signal power threshold
192. Slider to manually adjust the time duration threshold
193. Bottom bar of the interface which contains all the signal processes algorithmically
194. Single tile in the bottom bar represents one of the processed neurological signals
195. Toggle button to switch between manual or automated mode for signal processing
196. Visual representation of numerical value of the algorithmically processed signal
197. Numerical representation of the predefined time duration threshold
198. Computer user interface to interact with the IoT devices
199. Representation of the predefined signal power threshold
200. Real-time representation of a live neurological signal from a human subject
201. Set of interactive buttons to connect sensors and display their real-time status
202. Right section of the interface containing IoT interface
203. Visual determination if a smart device or Internet of Things (IoT) smart device is on or off
204. Example of an activatable smart device or Internet of Things (IoT) smart device
205. Top section of the computer user interface containing elements from [213] and [220]
206. Numerical representation of the signal power threshold
207. Left sidebar of the interface containing the section for thresholds
208. Section in the computer user interface containing the settings for key thresholds
209. Slider to manually adjust the signal power threshold
210. Slider to manually adjust the time duration threshold
211. Bottom bar of the interface which contains all the signal processes algorithmically
212. Single tile in the bottom bar represents one of the processed neurological signals
213. Toggle button to switch between manual or automated mode for signal processing
214. Visual representation of numerical value of the algorithmically-processed signal
215. Numerical representation of the predefined time duration threshold
216. Representation of the predefined signal power threshold
217. Computer user interface to interact with a computer game
218. Interactive or reactive element in the computer game
219. Real-time representation of a live neurological signal from a human subject
220. Set of interactive buttons to connect sensors and display their real-time status
221. Interactive or reactive character in the computer game CLASSIFICATIONS
G06F3/015 Input arrangements based on nervous system activity detection, e.g. brain waves (EEG) detection, electromyograms (EMG) detection, electrodermal response detection
G06F3/048 Interaction techniques based on graphical user interfaces [GUI]
A61M2230110 Electroencephalographic signals
A61M2230/14 Electro-oculogram [EOG]
A61B5/0488 Electromyography
A61B5/04012 Analysis of electro-cardiograms, electro-encephalograms, electro-myograms

### RELEVANT PUBLICATIONS

Minmin Miao, Wenjun Hu, Hongwei Yin, Ke Zhang, “Spatial-Frequency Feature Learning and Classification of Motor Imagery EEG Based on Deep Convolution Neural Network”, Computational and Mathematical Methods in Medicine, vol. 2020, Article ID 1981728, 13 pages, 2020. https://doi.org/10.1155/2020/1981728.
Min-Ho Lee, O-Yeon Kwon, Yong-Jeong Kim, Hong-Kyung Kim, Young-Eun Lee, John Williamson, Siamac Fazli, Seong-Whan Lee, EEG dataset and OpenBMI toolbox for three BCI paradigms: an investigation into BCI illiteracy, GigaScience, Volume 8, Issue 5, May 2019, giz002, https://doi.org/10.1093/gigascience/giz002.
Martin Spüler, Questioning the evidence for BCI-based communication in the complete locked-in state, Apr. 8, 2019, https://doi.org/10.1371/joumal.pbio.2004750.
Fatemeh Fahimi, Zhuo Zhang, Wooi Boon Goh, Tih-Shi Lee, Kai Keng Ang and Cuntai Guan Inter-subject transfer learning with an end-to-end deep convolutional neural network for EEG-based BCI, Fatemeh Fahimi et al 2019 J. Neural Eng. 16 026007.
Jian Kui Feng, Jing Jin, Ian Daly, Jiale Zhou, Yugang Niu, Xingyu Wang, Andrzej Cichocki, “An Optimized Channel Selection Method Based on Multifrequency CSP-Rank for Motor Imagery-Based BCI System”, Computational Intelligence and Neuroscience, vol. 2019, Article ID 8068357, 10 pages, 2019. https://doi.org/10.1155/2019/8068357.
Felix Gembler, Piotr Stawicki, Ivan Volosyak, Exploring the possibilities and limitations of multitarget SSVEP-based BCI applications, Annu Int Conf IEEE Eng Med Biol Soc. 2016 August; 2016:1488-1491. doi: 10.1109/EMBC.2016.7590991.
Klh S., Kaufmann T., Zickler C., Halder S., Leotta F., Cincotti F., Aloise F., Riccio A., Herbert C., Mattia D., Kubler A. (2012). Out of the frying pan into the fire—the P300 based BCI faces real world challenges. Prog. Brain Res. 194, 27-46 10.1016/B978-0-444-53815-4.00019-4.
Guger C., Daban S., Sellers E., Holzner C., Krausz G., Carabalona R., Gramatica F., Edinger G. (2009). How many people are able to control a P300-based brain-computer interface (BCI)?Neurosci. Lett. 462, 94-98 10.1016/j.neulet.2009.06.045.
B. Blankertz et al., “The BCI competition Ill: validating alternative approaches to actual BCI problems,” in IEEE Transactions on Neural Systems and Rehabilitation Engineering, vol. 14, no. 2, pp. 153-159, June 2006, doi: 10.1109/TNSRE.2006.875642.

1. A method comprising of at least one neurological signal from a human subject obtained from the prefrontal cortex without any external stimulus wherein the power of the at least one neurological signal is measured against a predefined signal power threshold and a predefined time duration threshold to generate a trigger, activation or control of a computer user interface.

2. A method comprising of at least one neurological signal from a human subject obtained from the prefrontal cortex without any external stimulus wherein the power of the at least one neurological signal is determined to be below, at or above a predefined signal power threshold within a predefined time duration threshold and if below the predefined signal power threshold, the neurological signal stops or does not generate a trigger, activation or control of a computer user interface and if at or above a predefined signal power threshold within a predefined time duration, the neurological signal generates a trigger, activation or control of a computer user interface.

3. A method of claim 1 wherein the power of the at least one neurological signal is measured either manually or automatically against a predefined signal power threshold and a predefined time duration threshold.

4. A method of claim 2 wherein the power of the at least one neurological signal is manually or automatically determined to be below, at or above a predefined signal power threshold within a predefined time duration threshold.

5. A system of claim 2 wherein musical tracks or musical playlists can be played, paused, or forwarded to the next musical track by the power of at least one neurological signal without any external stimulus.

6. A system of claim 2 wherein videos or video playlists can be played, paused, or forwarded to the next video by the power of at least one neurological signal without any external stimulus.

7. A system of claim 2 wherein communication can be generated by the power of the at least one neurological signal without any external stimulus.

8. A system of claim 2 wherein a smart assistant or Internet of Things (IoT) smart device can be triggered, activated or controlled by the power of at least one neurological signal without any external stimulus.

9. A system of claim 2 wherein a computer game or any element of a computer game can be triggered, activated, controlled or played with by the power of at least one neurological signal without any external stimulus.
